(19) United States
(12) Patent Application Publication
(10) Pub. No.: US 2007/0185875 A1
(43) Pub. Date: Aug. 9, 2007

(54) Extensible role based authorization for manageable resources

(75) Inventors: David Yu Chang, Austin, TX (US); John Yow-Chun Chang, Austin, TX (US); Vishwanath Venkataramappa, Austin, TX (US)

Correspondence Address: MCGRATH, GEISSLER, OLDS & RICHARDSON, PLLC, P.O. BOX 7085, ALEXANDRIA, VA, 22307, US

(73) Assignee: International Business Machines Corporation

(21) Appl. No.: 11/351,035

(22) Filed: Feb. 9, 2006

(51) Int. Cl. G06F 17/30

(52) U.S. Cl. 707/9

(57) ABSTRACT

Methods and systems are provided for dynamically altering the access capabilities to the data resources for users of a computer based application. The access capabilities are defined by a dynamic role that specifies which of the resources a user may access, and a set of permissions associated with the dynamic role to define. New dynamic roles may be created when additional resources and components are added to an application. Methods and systems are provided for creating new dynamic roles to temporarily access resources, and for deleting a dynamic role after it is no longer needed.

### BACKGROUND

1. Field

The present invention relates to software, and more specifically to the security and access constraints for a software system.

2. Background

FIG. 1 depicts the security arrangement 100 in a complex administrative software application for limiting access to the resources of the application—that is, to the data used in the application. Complex administrative software applications often have many components with which users can view or interact with the resources associated with the application. Quite often components are added over time to provide more capabilities to the application. The administrative software for each component should be secured so that authorized users can administer each component. However, the various different software components may have any one of several different security constraints. Access Control List (ACL) is one conventional approach for securing administrative software components. ACL serves as an access control mechanism by maintaining and referring to an access control list for each object on a computer to determine whether a particular user is to be given access. Each object is assigned a security attribute identifying its access control list, and the list has an entry for each user with access privileges, such as the ability to read a file, write to the file, or execute the file. Conventional security arrangements, such as ACL, suffer from the drawback of inflexibility.

The security arrangement of FIG. 1 is a user authorization scheme in which users 101-115 are granted authorization to access manageable resources 125 and 127 based on the predefined role to which each respective user has been assigned. Administrative security systems generally have a number of defined roles for users. FIG. 1 depicts four roles which are used in some IBM systems, Administrator 117, Configurator 119, Operator 121 and Monitor 123. These roles may be defined as static roles, with each user assigned to a particular role having the authorization to access the resources of the system at a predefined capability for that role. In the example shown in the figure, each of the roles 117-123 can access all resources—resources 125-127—at the predefined capability for that role. For example, user 101 has been assigned the Administrator 117 role, and therefore has authorization for Administrator level access to all resources, e.g., Resource 125 and Resource 127.

Such approaches which rely upon statically defined roles for granting access sometimes create a problem due to inflexibility. For example, it may be desirable for a user with an administrator role for one resource to not have the administrator role for other resources. As shown in FIG. 1, user 101 and user 103 are both granted the Administrative role 117, and therefore both users can access all the resources in the system as Administrators, in this case, Resource 125 and Resource 127. In some situations it may be desirable for a user to have access to one of the resources but not the other. For example, it may be desirable for user 103 to have access to Resource 125 as an administrator but not Resource 127.

What is needed is a way to apply security constraints for each component dynamically as they are configured or added to the base software.

### SUMMARY

Embodiments disclosed herein address the above stated needs by providing systems and methods for dynamically providing access to a plurality of resources in a computer based application.

In at least one embodiment, the application is configured to detect changes which may affect the access scheme, determine which of the resources or components of the application are affected by the change, and also determine which of the user accounts are affected by the change. Upon granting the change in access, the application modifies a dynamic role of the user accounts to accommodate the change. A dynamic role specifies which of the resources the user account is authorized to access, and a set of permissions associated with the dynamic role specifies the access capabilities granted to the user account for accessing the resources.

In some embodiments the potential change to an access scheme of the application may include the addition of resources to the application, the addition of components to the application, registering a new user account with the application, and/or receiving a request for additional access to be granted to an existing user account. The association of a set of permissions, or a new permission, with an existing dynamic role may be considered a modification of the dynamic role, or a modification of the user's capabilities who is assigned to that dynamic role.

### BRIEF DESCRIPTION OF THE DRAWINGS

The accompanying drawings, which are incorporated in and constitute part of the specification, illustrate various embodiments of the invention. Together with the general description, the drawings serve to explain the principles of the invention. In the drawings:

FIG. 1 depicts an administrative security arrangement with statically defined roles for granting authorization to manageable resources;

FIG. 2 depicts an exemplary system 200 which may be used to implement an administrative security arrangement for granting authorization to manageable resources according to various embodiments of the invention;

FIG. 3 depicts an exemplary system 300 for granting extensible role-based authorization to manageable resources according to various embodiments of the invention;

FIGS. 4A and 4B depict a flowchart 400 depicting an exemplary process for managing the administrative security of an application and granting authorization to manageable resources according to various embodiments of the invention;

FIG. 5 depicts an exemplary hardware system 500 suitable for implementing the various embodiments of the invention; and

FIG. 6 depicts exemplary schemas for defining extensible roles.

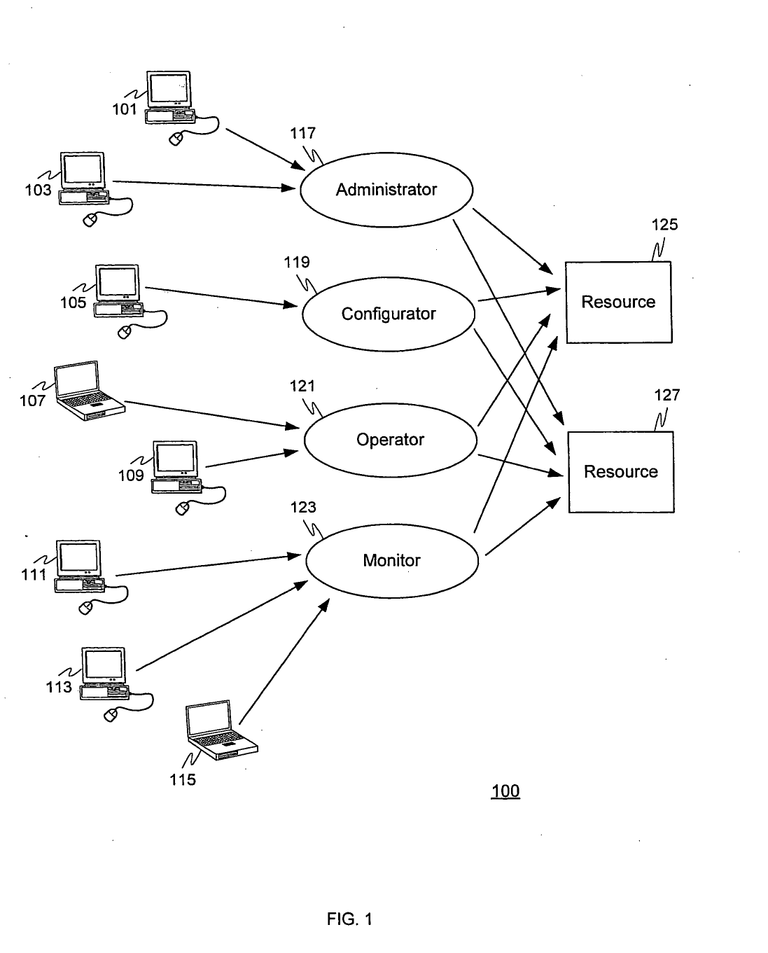

### DETAILED DESCRIPTION

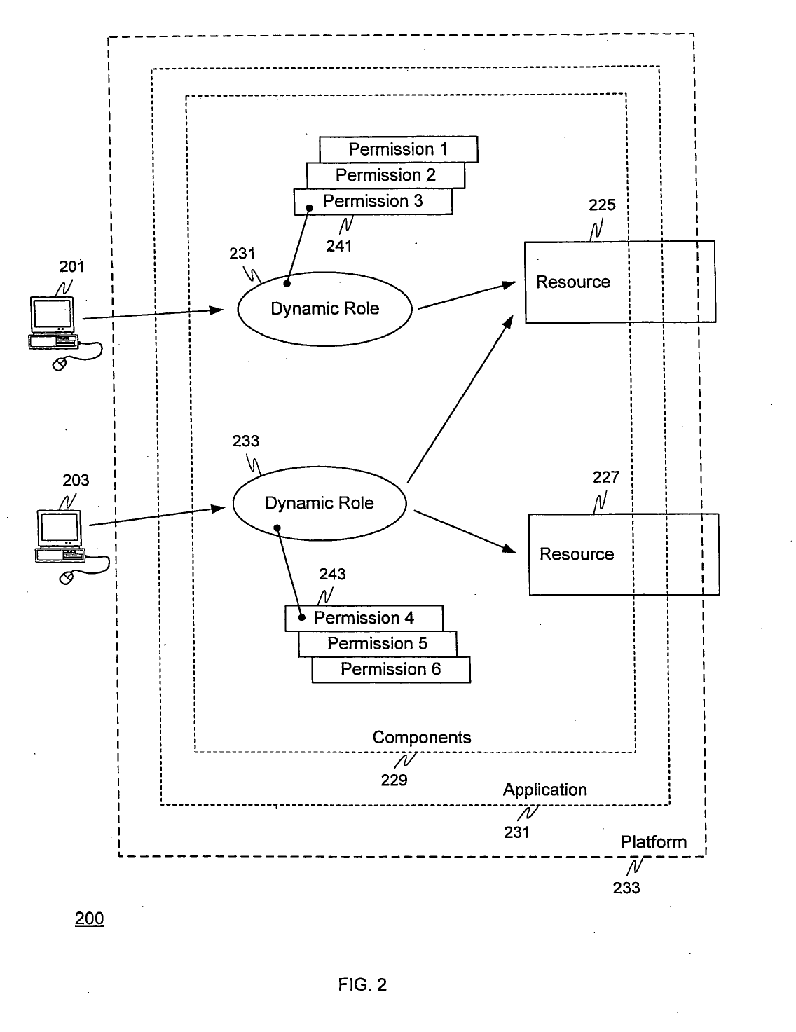

Various embodiments disclosed herein enable the dynamic creation of new roles or alteration of existing roles associated with permissions which allow users to access the manageable resources of a software application. A user's dynamic role and associated permissions allows the user to have different permissions and authorities for different resources. In this way, when a new manageable resource is created the administrator can create dynamic roles which are associated with the required permissions for that resource for the users who have differing needs for access to the resource. In some embodiments, a software application may have an initial set of role definitions and associated permissions, and new roles and permissions may be dynamically added after the application has been deployed, for example, to accommodate new components being added to application. FIG. 2 depicts a system 200 which may be used to implement an administrative security arrangement for granting extensible role-based authorizations to manageable resources. FIG. 2 also illustrates an exemplary relationship between a platform 233, an application 231, components 229 and resources 225-227, all of which are terms used herein to explain the various embodiments.

A platform 233, as this term is used herein, is a software framework, possibly including some aspects of hardware, which allows software applications 231 to run. A platform 233 may include an operating system, programming languages and/or their runtime libraries, as well as the computer's architecture, or selected aspects of it. A platform 233 may simply be thought of as a place to launch or operate software applications 231 or components 229. One example of a software platform is IBM's WebSphere Application Server. There are a great number of other examples of platforms, including, for example, IBM's Eclipse, an open integrated development environment (IDE) for creating web applications. Many other software platforms exist as well, as known by those of ordinary skill in the art.

An application 231 is a software program or code which runs on a platform 233 to perform a given purpose, satisfy a stated need, or manipulate and display resources in a desired manner. An application may be called a computer based application if its platform runs on a computer, server or other such state device. An application 231 may include, or be created from, a number of components 229. (A platform 233 may also include components separate from the application (not shown) which support functions of the platform 233 but are not directly part the application 231.) Software components 229 may take the form of modules, extensions, or custom configurations associated with an application. There are many examples of components which may be used as part of an application launched on a platform. Components may be thought of, in a sense, as the building blocks of an application (or a platform). Quite often components are subprograms, routines or bit of code that perform specific tasks. There are many examples of components used by developers to create applications. The extensible components that may be launched from the WebSphere platform include, for example, WebSphere Business Integration (WBI), WebSphere Portal and Java Message Service (JMS). Additional components such as these can be added to a platform such as WebSphere based on the requirements of the system or business for the platform.

The term resources, as this term is used herein, refers to the data used within or accessed by an application 231. In some implementations, the data of resources, for example, the resources 225-227 shown in FIG. 2, may be stored in a file separate from the application 231 and accessed by the application 231 or a component 229 of application 231. The resources 225-227, or a portion of them, may, in some instances, be stored as part of the application 231 itself or the application's components 229. As data, the resources 225-227 typically do not act on the application 231 or its components 229, but rather, the resources 225-227 are acted upon, edited, added to, deleted, or otherwise manipulated, by the application 231 and/or the components 229 of the application 231.

Terminals 201 and 203 shown in FIG. 2 represent users with user accounts authorizing them to interact with the application 231. A user with a user account is typically authorized in some capacity to access one or more resources associated with a software application running on a platform. For example, a user with a user account may be a person who has an on-line stock brokerage account, and by entering a user identification number and password the person may access their on-line stock brokerage account, and may view its information or enter commands to make stock trades. The term user may refer to any person authorized to access the application's resources by using a user account at a computer terminal connected to a network, or otherwise connected to a server. For ease in explaining the various embodiments, the terms “user” and “user with a user account” are used interchangeably in places herein in describing the invention, although in actuality a user account may be part of the system whereas a user (person) is not typically part of the system. Since a user accesses the platform via a computer by using a user account, the elements 201 and 203 of FIG. 2 are shown as computers rather than human users, but are referred to as users 201 and 203. In order to access or otherwise log on to an application 231 running on the platform 233, the users 201-203 may need to enter a password, enter an account number, connect a dongle or other identification hardware, impress a fingerprint or provide other biometric identification, or otherwise prove identification in a like manner known to those of ordinary skill in the art.

In understanding some of the terms used in describing the various embodiments, it may be useful to consider a real-world example involving a platform, an application, components and resources. Take, for example, a software system in a bank. The banking software may include a banking software application built on a WebSphere platform. The banking software application may have many different components, including modules or subroutines which perform the myriad different functions of the banking software application. The banking software application may allow users to access and manipulate resources (e.g., data) of the banking software application. The users may have many different roles, entitling them to gain access to a given set of resources at different levels and capabilities based on the permissions associated with a user account of each respective user. For example, the user roles may include a bank manager, a software programmer working for the bank, several bank tellers, customers with checking and savings accounts, customers with checking accounts and loans, customers with several different accounts and an Internet account, and the like. The resources may be the data for the various types of accounts, that is, checking accounts, savings accounts, loan accounts, and so on. So a user with a checking account and capabilities for Internet access will be assigned permissions to view data for her account either in person, via the Internet or possibly though the use of an automatic teller machine (ATM). However, the user will not be granted the permission to see other people's accounts, and the user will not be granted the permission to change the values in her account. On the other hand, a user who is a teller may be granted the permissions needed to access resources (data) from all banking customers. But in some banks the teller may not be able to alter account values to fix a bank error. The bank manager may have all the permissions of the tellers, but in addition she may be able to make changes to accounts to fix a minor bank error or take other such actions. The computer programmer employed to maintain and administrate the bank application software may be able to access the code, perform maintenance, and install software updates and patches, but would normally not be able to change the monetary values in the customers' accounts.

FIG. 2 depicts a system 200 having resources 225-227 which are accessed by users 201-203 via the components 229 and/or the software application 231. In the exemplary embodiment illustrated in the figure, access to the resources 225-227 is respectively granted to the various users based on the users' dynamic roles 231-233 and their associated permissions. The dynamic role for a given user specifies what resources the user is authorized to access. The permissions associated with that dynamic role specify the capacity, or capabilities or other manner in which the user is authorized to interact with a resource. In the example depicted in FIG. 2, dynamic role 231 allows user 201 to access resource 225. The permissions 241, which are associated with dynamic role 231, define the capacity in which the user 201 will be able to access resource 225.

The dynamic roles, such as the dynamic roles 231-233, are typically implemented using components 229. But in some embodiments the dynamic roles 231-233 may also be implemented as part of the application 231 itself. The various embodiments provide a robust, yet flexible, system of security by granting the user 201 access to resource 225 based on the dynamic role 231 which is characterized by the set of permissions 241 associated with this dynamic role. When a new resource is created or added to an application, new permissions may be created to selectively give the appropriate users access to the new resource and new roles may also be dynamically created.

As depicted in FIG. 2, dynamic role 233 allow user 203 to access both resource 225 and resource 227. As mentioned above a user's permissions, which are associated with the user's dynamic role, specify what capacity the user can access the various resources the user is authorized to access. The capacity in which user 203 can access resources 225 and 227 is defined by the permissions 243 granted to user 203. In accordance with various embodiments disclosed herein, a user's bundle of permissions associated with the user's dynamic role need not define the user to have the same privileges and capacities for all resources that the user can access. The user may have a greater or lesser capacity for accessing some resources as compared to others. The permissions 243 may define different privileges and capacities for the user 203 to access resource 225 versus accessing resource 227. For example, the permissions 243 (e.g., permission 4) may afford user 203 privileges of reading data when accessing resource 225, while the permissions 243 (e.g, permissions 5 and 6) could afford user 203 privileges to add, delete and edit data when for accessing resource 227.

The various embodiments disclosed herein can dynamically associate a set of permissions to the dynamic role of a user which apply in virtually any predefined manner of accessing the different resources for which the user is authorized. The dynamic roles and associated permissions are not limited to the four roles mentioned in the Background which are statically defined roles. The four roles mentioned in the Background—Administrator 117, Configurator 119, Operator 121 and Monitor 123—are examples of static roles internally defined by IBM for managing resources. For example, in accordance with some IBM systems which use statically defined roles, the Administrator role 117 is considered a super role, meaning that a user granted the Administrator role 117 can access all resources and perform almost any action. In such IBM systems with statically defined roles, a user granted the Configurator role 119 can only perform configuration changes to the resources (e.g., set properties or attributes of the resources managed). Similarly, IBM's Operator role 121 can perform some operations (e.g., perform some action on a managed resource) and users assigned the Monitor role 123 can only watch what is going on (e.g., observe the status of the managed resource). IBM has defined these roles in some software systems to manage the resources and isolate one user from other user so that each user has different responsibilities. Other systems using statically defined roles may need different roles defined for a particular function within the company or organization. For example, a banking software system may need a statically defined Manager role and statically defined Teller roles, and possibly customer roles. In another example, a company may have Employer and Employee roles. This differs from the dynamic creation of roles in which associated permissions provides the administrator of the application 231 with enough flexibility to tailor the bundles of permissions given to each particular user which closely suits the access requirements and needs that a particular user has for each resource. For example, by using the various embodiments herein a particular user may be assigned permissions giving the user right akin to that of an administrator for some predefined resources, and at the same time give the user rights akin to a monitor for other predefined resources. Of course the user's rights or permissions need not conform to any particular predefined role for any resource. Rather, the bundle of permissions may be tailored to specifically suit any situation or need that arises.

Typically, an administrator of the application 231 is provided with the authority to assign or otherwise associate dynamic roles to particular users or to classes of users. It should be noted that the ability to assign dynamic roles is itself a permission, and need not necessarily be tied to a predefined “administrator” role in the conventional sense. However, in an effort to ease the explanation of the various embodiments, the assignment of dynamic roles will be discussed in terms of being done by an administrator. As mentioned above, the administrator is not constrained to assigning predefined roles, and thus each resource can be uniquely accessed by different users depending up their access needs, the security needs of the application, or the preferences of the administrator making the assignment. The administrator may tailor a set of permissions for a given user, for a class of users, or even for a particular situation or a predefined timeframe. Referring to the banking software application discussed above, a situation may arise occasionally when a bank auditor comes to the bank to audit the books or inspect various accounts. The auditor may be set up as a use with a customized set of permissions allowing the bank auditor to access all resources (e.g., bank-related records and data) and possibly make print-outs, but not alter any of the resources. The bank auditors dynamic role may be set up to expire after a certain period of time, or possibly after a certain number of records or other measure of data have been inspected, edited or otherwise accessed. Such a dynamic role created on a temporary basis with tailored permissions, and often for a particular situation, may be referred to as a temporal role.

The various embodiments allow for new security roles and their associated permissions to be dynamically created. In this way the security and access policies for an application can be changed over time, or for a given situation. For example, new applications are sometimes added to a platform to provide additional capabilities. When this happens, one or more new permissions may be needed to manage the new application. The new permissions can be dynamically added at any time, for example, after the initial permissions have been set in place and implemented. These new permissions can either be dynamically added to the existing roles, or a new role can be created to manage the new application. When an application is removed, the previous permission associated with the removed application is typically removed as well. This aspect of the various embodiments differs from other conventional solutions in which the roles are predefined and constrained to certain permissions or lists of permissions. Such conventional solutions make the system inflexible.

For the ease of illustration, FIG. 2 depicts one user associated with each dynamic role. However, the various embodiments may be implemented with any number of users associated with a particular dynamic role. For example, dynamic role 231 could define the permissions for an entire class of users, and possibly be associated with hundreds or thousands of users, or more. On the other hand, a dynamic role may be tailored for a particular individual. For example, dynamic role 203 may define a unique bundle of permissions associated only with user 203. The various embodiments afford a great deal of flexibility in associating permissions with one or more users, and tailoring those permissions to meet the access needs of the system while maintaining the security requirements.

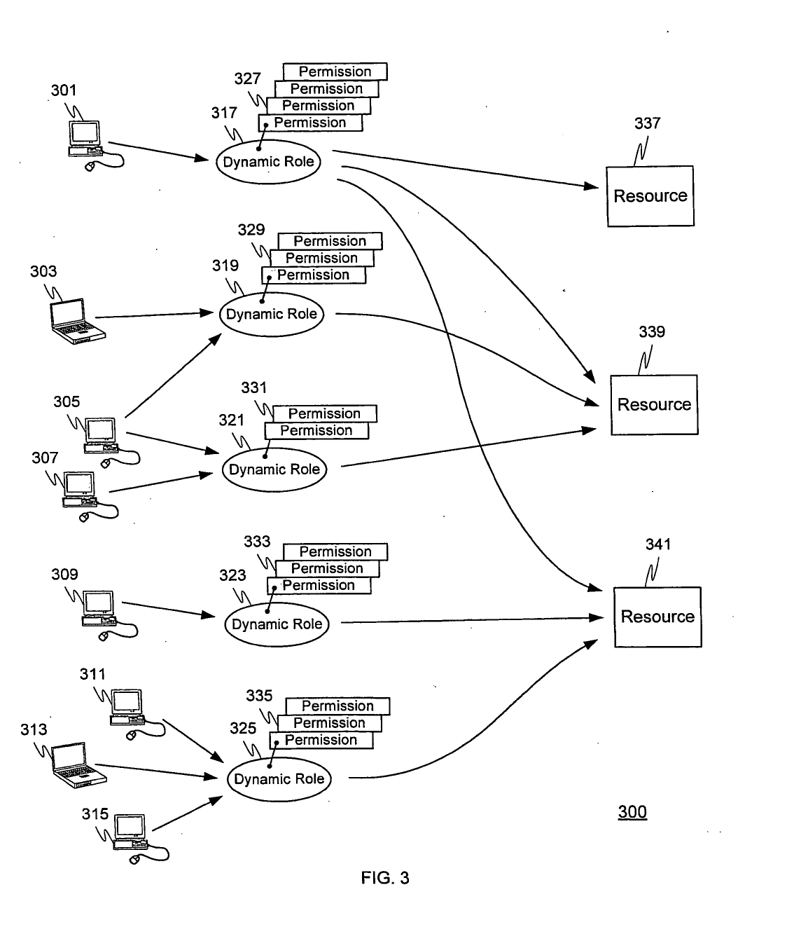

FIG. 3 depicts an exemplary system 300 for granting extensible role-based authorization to manageable resources. One aspect of the access scheme for role based authorization is the resource to role mapping which characterizes the resource permissions. The mapping between resources and roles describes the roles used to administer a given resource. The mapping of resources to roles can be seen by the arrows between resources 337-341 and dynamic roles 317-325, with each of the dynamic roles being respectively defined by a bundle of permissions 327-335. The mapping between resources and roles may be kept in the form of a list, a table, a set of pointers or reference indices, or any other convenient means of tracking the relationship mapping between resources and roles.

Another aspect of the access scheme for role based authorization involves mapping between roles and users. The mapping of dynamic roles to users defines which users are granted various roles. This, in turn, determines what different resource(s) each user may access. The permission(s) associated with a given dynamic role determines the capacity in which the user's access is defined. The mapping of roles to users may be seen in FIG. 3 by the arrows between dynamic roles 317-325 to users 301-315. In some embodiments, each user may map to a particular dynamic role. If a user needs more permissions or a combination of permissions not defined by any existing dynamic role, then a new dynamic role may be created. However, in other embodiments a particular user may be associated with more than one dynamic role. For example, user 305 is associated with both dynamic role 319 and dynamic role 321. The mapping between roles and users may be kept in the form of a list or a table such as an authorization table.

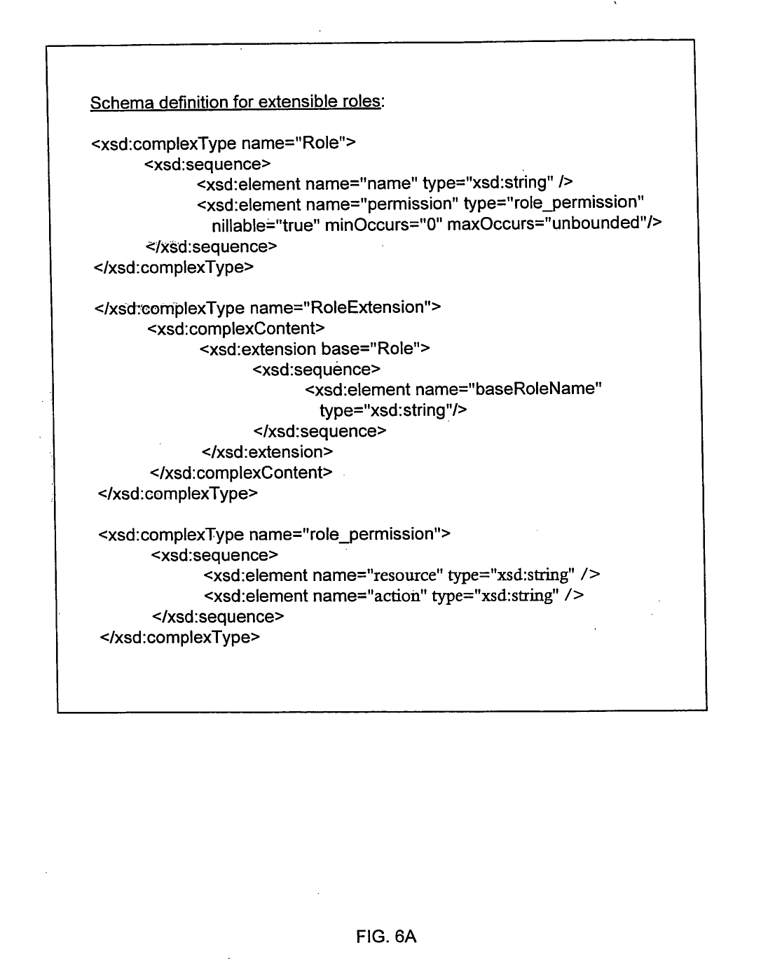

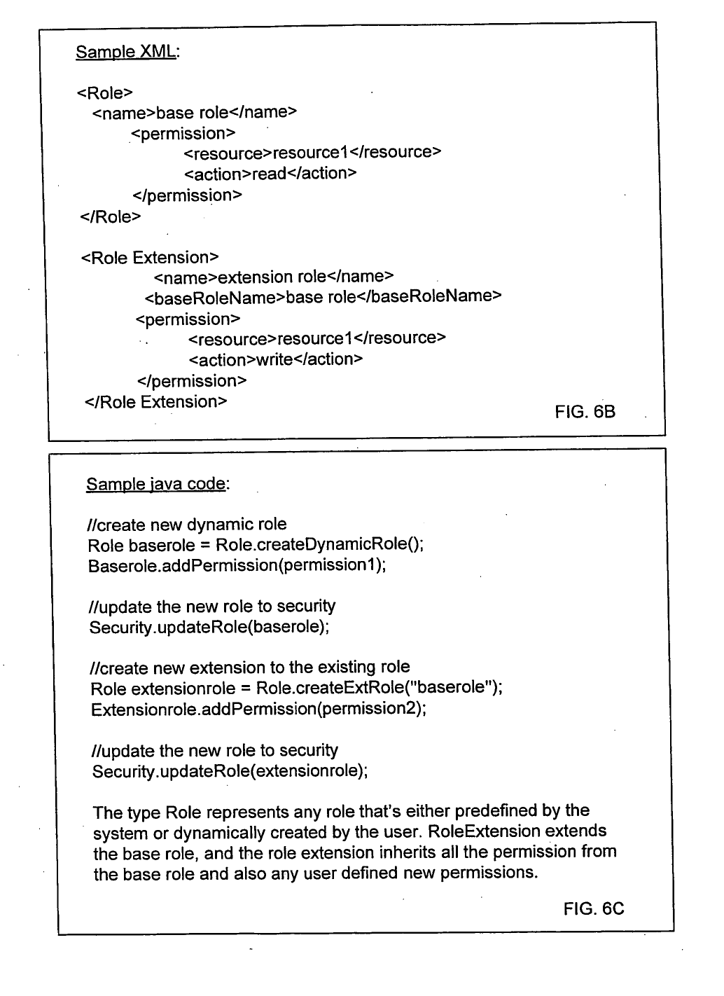

When a new administrative component is added to the application, resource permission for the resources associated with that component may also be added. This can be described in an XML file similar to the deployment descriptor of a J2EE application. Exemplary schemas for defining extensible roles are depicted in FIGS. 6A-6C, with a sample XML implementation shown in FIG. 6B. Once the resource permissions for the added component have been added, the authorization table (e.g., the user to role mapping) corresponding to that component is added.

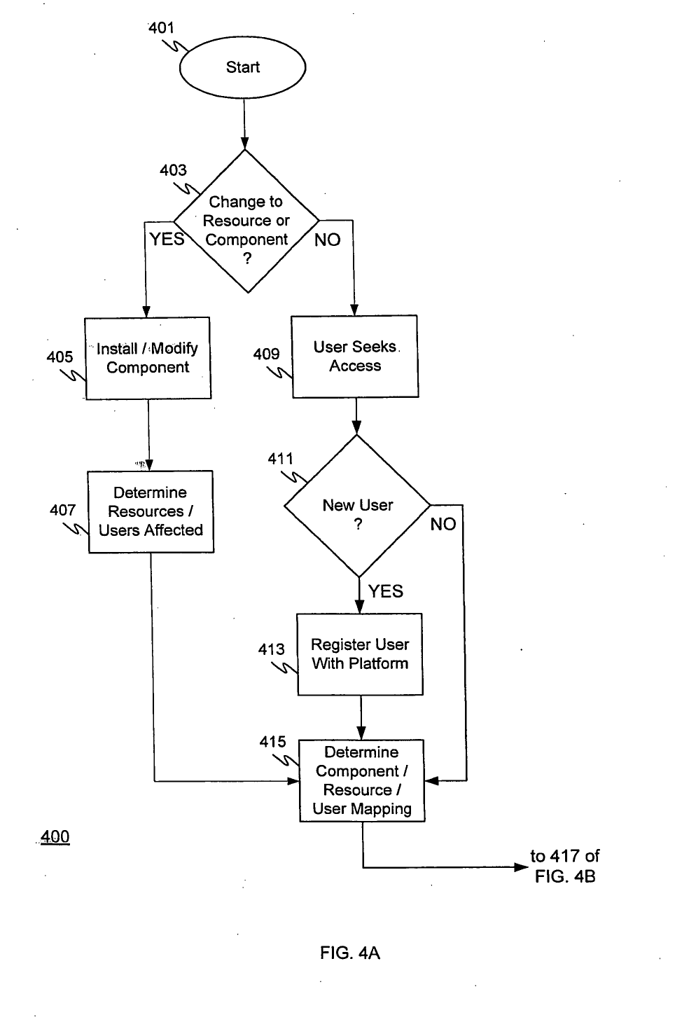

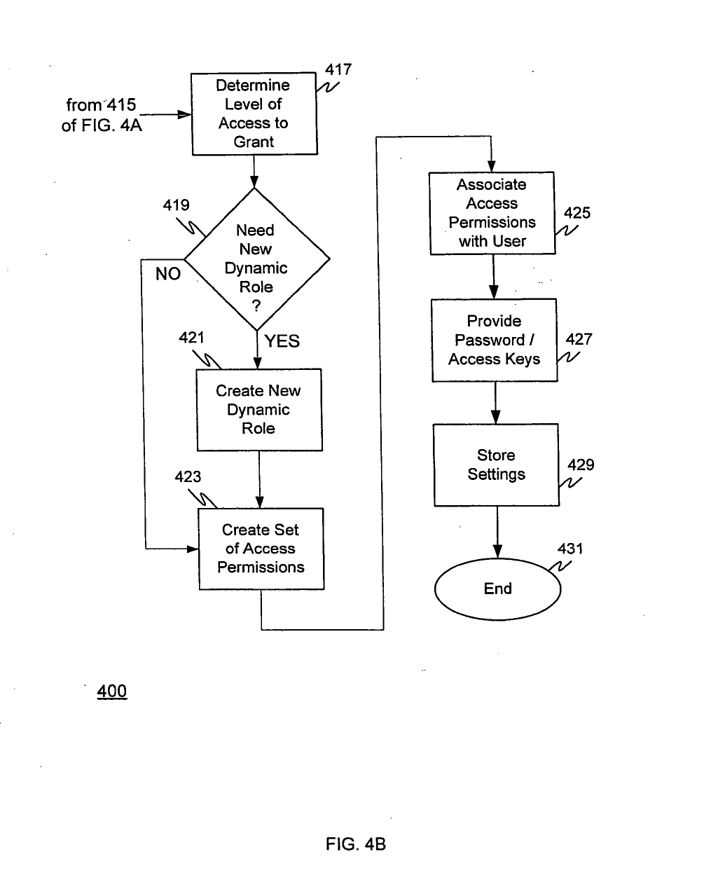

FIGS. 4A and 4B depict a flowchart 400 depicting an exemplary process for managing the administrative security of an application and granting authorization to manageable resources. The method starts at 401 of FIG. 4A and proceeds to 403 where a change to the access scheme is detected, the access scheme being the system of providing access to user accounts for the computer based application, for example, as shown in FIGS. 2-3. The change may be the addition of more resources or components, or may be a request by a user to change their access or a new user may be seeking to register with the system. The change may be thought of as a “potential” change until the system actually grants access to the user or incorporates the new resource or component.

In 403 the nature of the change potentially affecting the access scheme is also determined. That is, it may determined that a new component or resource has been added, or an existing component or resource of the application has been modified, or that there is a new user or an existing user seeking additional access. Such changes associated with the application may affect the access scheme of the application. If it is determined in 403 that a new component/resource has been added which may change the access scheme of the users, the method proceeds from 403 along the “YES” path to 405. The method will follow this same “YES” path to 405 if an existing component has been modified or some other change causes a component to provide different access to users, other than the addition of a new user or an existing user requesting additional access.

In 405 the component is added to the application or otherwise installed to run in conjunction with the application. Alternatively, it may be the case that new resources are installed on the system, modified, or changed in some manner that affects the access scheme for users. It may be the case that a new type of resource is added, or it may be the case that a means of accessing the resources is added or modified. For example, returning to the banking software application discussed above, the bank could begin providing stock brokerage services. In such an instance a new stock brokerage manager may be hired, along with a staff of analysts and sales people would be acting in different capacities than the bank manager and tellers, and therefore would require new dynamic roles and an associated set of permissions designed for stock brokerage services. In this example, the data characterizing the new stock brokerage accounts would be the new resources. A similar situation of adjusting the user access permissions occurs when components or resources are deleted from the application software. The method then proceeds to 407 to determine what resources will be affected, how that will affect the accessing of resources by the users, and what users will be affected. The method then proceeds to 415.

Back in 403, if it is determined that it is not the addition/modification of a component causing the change in resource access then the method proceeds from 403 via the “NO” branch to 409. In 409 it is determined what access the user seeks for a resource for which the user has not yet been authorized. By seeking access to a resource, it is meant that the user seeks to use, read or otherwise detect, edit, or otherwise manipulate the resources (e.g., data) of an application running on a platform. This may occur when an existing user logs into an application and tries to access a resource for which the user has no permissions, or the user may try to access a resource which the user normally accesses, but in a manner for which the user is not authorized. Alternatively, the user may seek access by sending a request to the administrator of the data asking for increased privileges for accessing resources. After detecting that a user seeks access to resources, the method proceeds from 409 to 411.

In 411 it is determined whether the user is an existing user registered with the application (who may have access to other resources) or is a new user. If, in 411, it is determined that the user is a new user, or additional registration information is required to access the resources sought, then the method proceeds from 411 along the “YES” branch to 413. In 413 the application registers the new user with the system, collecting the requisite user information and providing a user ID or other identification moniker, a password or other security verification device, and performing any other registration activities deemed necessary. Once the user has been registered in 413, the method proceeds to 415. However, back in 411, if it is determined that the user is not a new user and registration is not necessary, the method proceeds from 411 along the “NO” branch to 415.

In 415 it is determined what components and resources the user seeks to access. Typically, the components which are sought can be established by considering the resources and the permissions that are sought, and then determining which components are needed to access the resources in the manner desired by the user. The role based authorizer typically performs an access check based on the resource and the corresponding administrative component. This determines the roles required to access a give resource. Once it has been determined in 415 which components and resources are being sought the method proceeds to 417 of FIG. 4B.

In 417 it is determined whether to grant the user access to the resources, and if so, what level of access is to be granted to the user. This decides the set of access permissions to be granted to the user. The granting of user access to the resources may be performed automatically by the system, in accordance with a predefined scheme, or it may be done by a human administrator, or a combination of both. For example, the administrator may look at the authorization table corresponding to that administrative component to determine whether the user is granted the required role. If administrator approves and the user is granted the required role, then access to the user will be allowed, to the extent of the granted permissions. Otherwise the administrator may choose to deny access to the user. A feature of the various embodiments disclosed herein is that the permissions to be granted to a user can be uniquely tailored to each different user depending up the user's access needs, the security constraints of the application, and the preferences of the administrator controlling the grant of permissions. In addition to granting additional permissions to a user, in some instances permissions may be taken away from a user if the user no longer has the authority or need to access certain resources. The administrator may dynamically create a role for the user with a set of permissions for that specific user, for a class of users, or even assign a temporal dynamic role for a particular situation or a given predefined timeframe. In this way the various embodiments afford the administrator a great deal of flexibility in granting the user access to the resources of the application on the basis of a dynamic role characterized by a set of permissions associated with that dynamic role. Once it has been determined in 417 to grant access to resources at a dynamically determined level of access, the method proceeds to 419.

In 419 it is determined whether or not the access sought by the user can be accommodated by an existing, previously created dynamic role. The previously created dynamic roles are evaluated to see if there is there is already a dynamic role associated with a set of permissions for the requested resources which would satisfy the user's request. If there is such a dynamic role with the appropriate set of permissions and no new dynamic role is needed, then the method proceeds from 419 along the “NO” branch to 243. However, if it is determined in 419 that there is no existing dynamic role suitable to accommodate the user's need for access to resources, then the method proceeds from 419 along the “YES” branch to 421. In block 421 a new dynamic role is created to accommodate the user's request for access to given resources with a set of permissions. For example, the user may be a customer of a bank who has a savings account, a checking account at the bank, as well as a loan for a home mortgage. The user may be requesting Internet access to the banks services. Since, presumably, no other bank customers have Internet access to that bank customer's accounts (e.g., which may be called “resources”, in the context of the bank's software system), a new dynamic role may be set up for the user requesting Internet access. Back in FIG. 4B, once the new dynamic role has been created in 421 the method proceeds to 423.

In 423 a set of one or more permissions is created and associated with the dynamic role assigned to the user. It may occur that the dynamic role has previously been defined, in which case the predefined dynamic role can be used instead of a newly created role, for example, created in 421. In either situation, once the access permission set has been created in 423 the method proceeds to 425 to associate the created permission set with the user. In block 425 the permissions, for example, as determined in 417, are associated with the user's dynamic role. This may be considered a modification of the user's dynamic role, since the new permissions afford the user a different level of access to resources. In some instances the user's access may be reduced. For instance, it may be that a person with a bank account at a certain bank withdraws all of the funds from their passbook saving account and closes the account. In such an example, the bank's software application would be modified, using the method described above, to remove the user's permissions to view and/or access their savings account, since the account had been closed. Or in this same example, if the user closed all of their accounts at the bank, then it would be appropriate to take away all of the user's permissions as well as the user's dynamic role.

In addition, at this time any passwords or other types of security/identification verifiers may be provided to the user in 427 to facilitate gaining access to the desired resources. The method then passes to 429 to store the user profile, the user's dynamic role including the newly created or modified permission set which has been assigned to the user. Once the requisite information has been stored the method proceeds to 431 and ends.

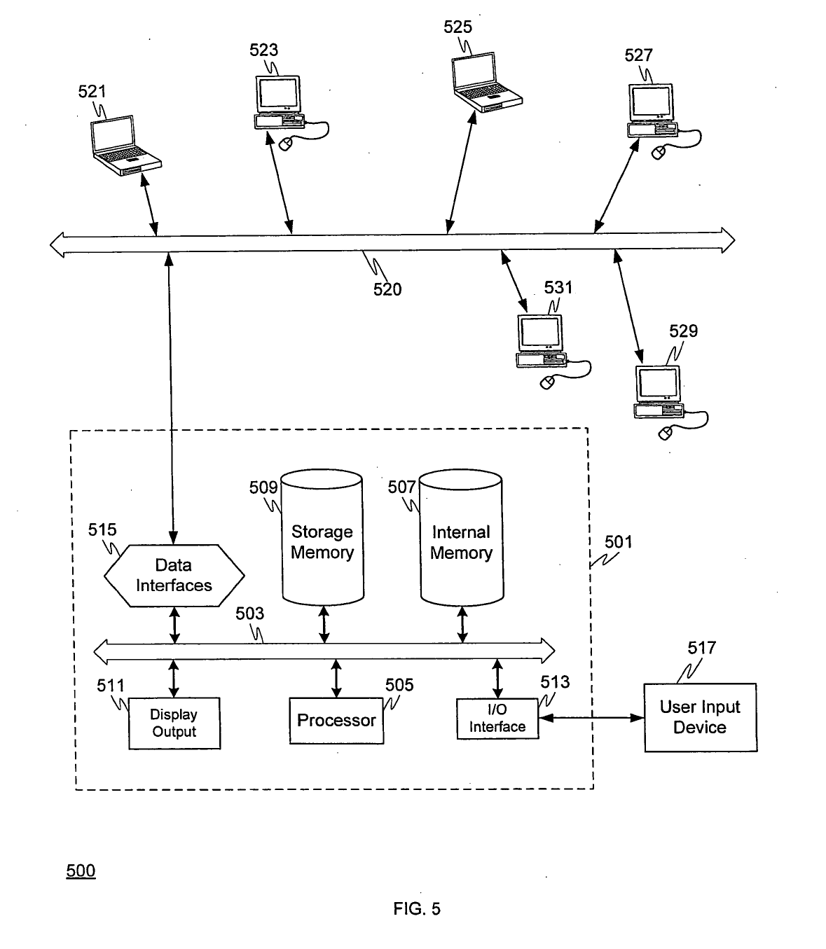

FIG. 5 depicts an exemplary hardware system 500 suitable for implementing the various embodiments of the invention. The figure shows a block diagram of a typical information handling system 501 hardware configuration which includes processor 505. The processor 505 may be implemented as a central processing unit (CPU) containing circuitry or other logic capable of performing or controlling the processes, steps and activities involved in practicing the embodiments disclosed herein. The processor 505 may be embodied as either a microprocessor or an application specific integrated circuit (ASIC), may be a combination of two or more distributed processors, or any other circuitry or logic capable of carrying out commands or instructions, for example, the routines for managing the administrative security of a software application and granting authorization to the manageable resources of the application. In various embodiments, the processor 505 may run a computer program or routine which performs one or more of the activities depicted in FIGS. 4A-4B, or otherwise discussed above.

The processor 505 is interconnected to internal memory 507 and storage memory 509. The components of the information handling system 501 are typically interconnected via one or more buses, represented in FIG. 5 as bus 503. For example, the processor 505 is configured to communicate with internal memory 507 and storage memory 509 via the bus 503 or by way of another like type of wired or wireless communication links. Although the bus 503 is depicted as a single bus connecting all of the component parts of the system, the information handling system 501 may include two or more separate buses each connected to a subset of the system components.

The internal memory 507, sometimes referred to as a local memory, may be any of several types of storage devices used for storing computer programs, routines, or code, including the instructions and data for carrying out activities of the various embodiments such as the activities discussed herein. The internal memory 507 and storage memory 509 may be implemented in any form suitable for storing data in a computer system, for example, as random access memory (RAM), read only memory (ROM), flash memory, registers, hard disk, or removable media such as a magnetic or optical disk, or other storage medium known in the art. Either of the memories 507 and 509 may include a combination of one or more of these or other such storage devices or technologies. An application with its platform and any associated resources may be stored in storage memory 509 of the computer system 501, or in another information handling system (e.g., 521-531) being utilized as a server. The internal memory 507 and storage memory 509 may each be configured to store all or parts of a computer program product which performs the various activities in creating a customized wrapper for a web application.

The information handling system 501 also includes one or more input/output (I/O) units such as user display output 511 and user input device 517. The user output display 511 may be implemented in the form of any visual output device, and may be interfaced to bus 503 by a graphics adapter (not shown). For example, the user output display 511 may be implemented as a monitor, such as a cathode ray tube (CRT) or a liquid crystal display (LCD) screen or other like type of computer screen. Typically, the output 511 (e.g., computer screen) displays a view controlled by the application which acts in response to the application being executed by processor 505 or another processor of the system 500. The user output 511 may include one or more audio speakers as well as a video monitor. The information handling system 501 typically includes one or more user input devices 517 such as a keyboard, a mouse, a tablet surface and pen, a microphone and speech recognition routine, or other like types of input/output devices. The user input device 517 may be interfaced to bus 450 by an I/O interface 513. The user output 511 and user input 517 may include other devices known to those of ordinary skill in the art and suitable for use with a computer system.

The information handling system 501 is typically configured to include data interface unit 515 suitable for connecting to one or more networks 520 such as the Internet, a local area network (LAN), a wide area network (WAN), the Public Switched Telephone System (PSTN), a wireless telephone network, or the like. The data interface unit 515 may include a wired and/or wireless transmitter and receiver. The data interface unit 515 may be implemented in the form of multiple units, including, for example, a modem and a network adapter. The information handling system 501 may be connected via the network 520 to one or more other information handling systems, computers, dumb terminals, or telecommunications devices 521-531 which participate in running or carrying out instructions from the application, for example, to implement the various activities disclosed herein.

Various activities may be included or excluded, for example, as described above in conjunction with the figures, and especially FIGS. 4A and 4B. Various activities may be performed in a different order than that shown in FIGS. 4A and 4B, yet remain within the scope of at least one exemplary embodiment. For example, blocks 411-413 which determine whether the user is a new user or an existing user may be performed before the user seeks access to resources in 409. Or, in another instance, the activities performed in block 427 involving the assignment of password/access keys to the user may not need to be performed in each instance of modifying a user's access. Unless a new grant of additional access warrants a different password or access key, the performance of block 423 may be performed as part of the registration process 413.

The invention may be implemented with any sort of processing units, processors and controllers (e.g., processor 505 of FIG. 5) capable of performing the stated functions and activities. For example, the processor 505 may be embodied as a microprocessor, microcontroller, DSP, RISC processor, or any other type of processor that one of ordinary skill would recognize as being capable of performing the functions described herein. A processing unit in accordance with at least one exemplary embodiment can operate computer software programs stored (embodied) on computer-readable medium such as the memories 507-509, e.g. hard disk, CD, flash memory, ram, or other computer readable medium as recognized by one of ordinary skill in the art, or the computer software programs may be transmitted wirelessly to the processing unit. The software application can aid or perform the steps and activities described above. For example, an application in accordance with at least one exemplary embodiment may include: source code for detecting that a user is seeking access to resources, determining the components/resources appropriate for the access, determining the requisite permissions or levels of access to grant to the user, creating the permissions and associating them with the user's dynamic role, storing the settings and user profile, and any other activities performed in carrying out at least one embodiment enabled herein.

The use of the word “exemplary” in this disclosure is intended to mean that the embodiment or element so described serves as an example, instance, or illustration, and is not necessarily to be construed as preferred or advantageous over other embodiments or elements. The description of the various exemplary embodiments provided above is illustrative in nature and is not intended to limit the invention, its application, or uses. Thus, variations that do not depart from the gist of the invention are intended to be within the scope of the embodiments of the present invention. Such variations are not to be regarded as a departure from the spirit and scope of the present invention.

What is claimed is:

1. A method for dynamically providing access to a plurality of resources in a computer based application, the method comprising:
detecting a change associated with the application potentially affecting an access scheme of the application, wherein the application includes a plurality of components;
determining which of said plurality of resources of the application are affected by the change;
determining which of said plurality of components of the application are affected by the change;
determining at least one user account among a plurality of user accounts affected by the change; and
modifying or creating a dynamic role of said one user account to accommodate the change.

2. The method of claim 1, further comprising:
destroying the dynamic role upon determining that the dynamic role is no longer needed.

3. The method of claim 1, wherein the dynamic role specifies which of said plurality of resources the user account is authorized to access.

4. The method of claim 3, wherein a set of permissions associated with the dynamic role specifies access capabilities granted to the user account for accessing said plurality of resources.

5. The method of claim 4, further comprising:
modifying the set of permissions to change the access capabilities.

6. The method of claim 5, wherein said modifying of the set of permissions includes adding a new permission.

7. The method of claim 4, further comprising:
storing the dynamic role and the set of permissions for the user account in said application.

8. The method of claim 1, wherein said change includes at least one of: adding additional resources to the application, adding additional components to the application, registering a new user account with the application, or receiving a request for additional access to be granted to an existing user account.

9. The method of claim 1, wherein said access to resources is limited to a plurality of user accounts registered with the application.

10. A computer program product for dynamically providing access to a plurality of resources in a computer based application, the computer program product comprising a computer useable medium including a computer readable program, wherein the computer readable program upon being executed on a computer causes the computer to:
detect a change associated with the application potentially affecting an access scheme of the application, wherein the application includes a plurality of components;
determine which of said plurality of resources of the application are affected by the change;
determine which of said plurality of components of the application are affected by the change;
determine at least one user account among a plurality of user accounts affected by the change; and
modify or create a dynamic role of said one user account to accommodate the change.

11. The computer program product of claim 10, further causing the computer to:
destroy the dynamic role upon determining that the dynamic role is no longer needed.

12. The computer program product of claim 10, wherein the dynamic role specifies which of said plurality of resources the user account is authorized to access; and
wherein a set of permissions associated with the dynamic role specifies access capabilities granted to the user account for accessing said plurality of resources.

13. The computer program product of claim 12, further causing the computer to:
modify the set of permissions to change the access capabilities.

14. The computer program product of claim 13, wherein said modifying of the set of permissions includes adding a new permission.

15. The computer program product of claim 12, further causing the computer to:
store the dynamic role and the set of permissions for the user account in said application.

16. A system for dynamically providing access to a plurality of resources in a computer based application, the system comprising:
a memory configured to store the plurality of resources and the computer based application;
logic for detecting a change associated with the application potentially affecting an access scheme of the application, wherein the application includes a plurality of components;
logic for determining which of said plurality of resources of the application are affected by the change;
logic for determining which of said plurality of components of the application are affected by the change;
logic for determining at least one user account among a plurality of user accounts affected by the change; and
logic for modifying or creating a dynamic role of said one user account to accommodate the change.

17. The system of claim 16, wherein the dynamic role specifies which of said plurality of resources the user account is authorized to access; and
wherein a set of permissions associated with the dynamic role specifies access capabilities granted to the user account for accessing said plurality of resources.

18. The system of claim 17, wherein said logic for modifying the dynamic role is configured to modify the set of permissions to change the access capabilities.

19. The system of claim 16, wherein the memory is further configured to store the dynamic role and the set of permissions for the user account in said application.
